(19) United States
(12) Patent Application Publication
(10) Pub. No.: US 2016/0103077 A1
(43) Pub. Date: Apr. 14, 2016

(54) LIQUID CONTAMINANT SENSOR SYSTEM AND METHOD

(71) Applicant: Purewater Medical, Inc., Longmont, CO (US)

(72) Inventors: Mark Forrest Smith, Longmont, CO (US); W. Mark Davis, Louisville, CO (US); Justin Charles Smith, Broomfield, CO (US)

(73) Assignee: PUREWATER MEDICAL, Inc.

(21) Appl. No.: 14/859,285

(22) Filed: Sep. 19, 2015

Related U.S. Application Data
(60) Provisional application No. 62/063,312, filed on Oct. 13, 2014.

(51) Int. Cl. G01N 21/85; G01N 21/94; G01N 15/14

(52) U.S. Cl. CPC G01N 21/85; G01N 15/1429; G01N 21/94; G01N 2015/1493

(57) ABSTRACT

A liquid contaminant sensor system and method. An example system includes at least one light source. The example system includes at least one light detector to receive a light signal from the at least one light source. The example system includes a signal processor to compare the light signal received at the at least one light detector with a reference signal and determine if a particle is present in a liquid. An example liquid contaminant sensor method includes emitting a light into a detection path and a reference path, detecting a light signal from the detection path and the reference path, and comparing the light signal with a reference signal to determine if a particle is present in a fluid. In an example, a fluid path is split into a detection path and a reference path. In another example, the fluid path includes both the detection path and reference path.

### CROSS REFERENCE TO RELATED APPLICATION

This application claims the priority benefit of U.S. Provisional Patent Application No. 62/063,312 filed Oct. 13, 2014 for “Contaminant Monitoring System and Method,” hereby incorporated by reference in its entirety as though fully set forth herein.

### BACKGROUND

Sterile medical solutions are commonly used for medical procedures. For example, a common surgical procedure can use 30 liters or more of irrigation fluid. In the United States alone, there are currently about ten million surgical procedures performed every year that use irrigation fluid. Other applications, such as Continuous Renal Replacement Therapy (CRRT), can use more than 150 liters of fluid. Nearly 30% of intensive care unit (ICU) patients experience kidney failure, needing CRRT. There are over 200,000 annual CRRT treatments. In addition, there are currently over 30,000 home hemodialysis patients worldwide.

A liquid electrical conductivity measurement of the water can be used to confirm that chemical contaminants have been removed. However, confirming that biological contaminants have been removed typically requires that samples be sent to a lab for testing. Testing can take several days before the results are known. During this time, either the water cannot be used for medical purposes or there is a risk of contamination.

### BRIEF DESCRIPTION OF THE DRAWINGS

FIG. 1 is a system diagram of an example liquid particle sensor system.

FIG. 2A is a top view of an example liquid contaminant sensor system; and FIG. 2B is a side view of an example liquid contaminant sensor system.

FIG. 3 is a cut-away view of an example liquid contaminant sensor system.

FIG. 4 is a schematic diagram of an example detection circuit for a liquid contaminant sensor system.

FIG. 6 is a system diagram of an example liquid contaminant sensor system.

FIG. 6 is perspective view of an example liquid contaminant sensor system.

FIG. 7A is a top view of an example liquid contaminant sensor system; FIG. 7B is a side view of an example liquid contaminant sensor system; and FIG. 7C is an end view of an example liquid contaminant sensor system.

FIG. 8A is a top view of an example liquid contaminant sensor system; FIG. 8B is a side view of an example liquid contaminant sensor system; and FIG. 8C is an end view of an example liquid contaminant sensor system.

FIG. 9 is plot showing response of an example liquid contaminant sensor system.

FIG. 10 is flow chart showing example operations of a liquid contaminant sensor method.

### DETAILED DESCRIPTION

The Environmental Protection Agency (EPA) defines Primary Drinking Water according to the National Primary Drinking Water Regulations, as suitable for human consumption. While EPA Primary Drinking Water (often referred to as “tap” water) is suitable for human consumption, this water has not been sufficiently purified to meet the standards for medical use. Further purification is necessary in order to produce water that is suitable for medical use. A requirement for medical applications is that purified water be checked prior to use to verify that chemical and biological contaminants have been removed to predefined standards.

A system and method is disclosed which may be implemented to ensure that contaminants have been removed from water or other fluid. In an example, the system and method may be implemented to check the effluent of a water purification system to ensure that the purified water meets the standards for medical applications. However, the system and method described herein may be implemented to check any water or liquid for any desired end-use and/or requirements.

In an example, the system and method is embodied as a Liquid contaminant Sensor (LPS) with a safety check circuit implementing non-contact particle detection. The LPS may include at least one light source, at least one light detector to receive a light signal from the at least one light source, and a signal processor to compare the light signal received at the at least one light detector with a reference signal and determine if a particle is present in a liquid. The LPS may be implemented in-line with a water purification system to monitor for contaminants substantially in real-time (e.g., as the water is being purified). An in-line configuration eliminates the need to take samples and send those samples to a laboratory for testing. As such, the in-line configuration avoids delays in correcting problems with the purification process and expedites production of a purified water, e.g., for medical applications.

In an example, the LPS may be implemented as a flow cell which can be connected in-line with a fluid path. The fluid path may be split into separate paths or “sensing channels.” The LPS may include at least one light source for each sensing channel, and at least one light detector for each sensing channel. According to a split path configuration, the reference signal is from one of the sensing channels while the test signal is from the other sensing channel. It is noted, however, that fluid path does not need to be split. In such a configuration, the reference signal and the test signal may both be derived from the same flow path or sensing channel.

In an example, the LPS may include a light source driver to emit a high power pulse of light from the at least one light source. In an example, the LPS may include at least one integrating sphere. In an example, the LPS may include a light signal conditioner. In an example, the LPS may include a light polarizer to polarize the light signal. In an example, the LPS may include an optical coupling of the at least one light source to a flow cell. For example, the LPS may include one or more light pipe to couple the at least one light source to the sensing channel. Other optical coupling techniques may also be provided. The LPS may also implement a pulsing light source to reduce/cancel the noise.

In an example, the light detector(s) of the LPS may be configured as a differential signal detector across at least one flow path. In an example, the LPS may include an optical collector to collect a light signal for the light detector. In an example, the LPS may include synchronous modulation/demodulation processor or a lock-in amplifier to improve the signal to noise ratio (SNR). In an example, the LPS may include a processor configured to output size, count of particle in the liquid, and/or other processed data.

In an example, the system and method may be implemented to monitor for chemical and/or biological particles. For example, the LPS may include a safety check circuit to process at least two checks, a first check for the presence of chemical contaminants (either as a series of tests for individual elements/molecules or as a compound test to characterize the total amount of contaminants (e.g. conductivity), and a second check for biological contamination. The system and method may also be implemented to monitor for other particles and/or contamination.

In an example, the system and method may be implemented as a flow through ultrapure fluid biological quality sensor. In an example, the contaminant monitoring system and method can count/detect particles of at least about 5 nm in size. Multiple wavelengths may be used for measuring particle size. In an example, Mie scattering and Raleigh scattering principles may be implemented to determine particle size. For example, Pyrogens having a 3 to 200 nm size can be identified based on Rayleigh scattering; Viruses having a 5 to 1,000+ nm size can be identified based on Rayleigh+Mie scattering; and Bacteria having a 200 to 30,000 nm size can be identified based on Mie scattering. Accordingly, an assessment of the biological quality of water may be made based on particle counting (e.g., to identify endotoxin, virus, and bacteria).

Before continuing, it is further noted that as used herein, the terms “includes” and “including” mean, but is not limited to, “includes” or “including” and “includes at least” or “including at least.” The term “based on” means “based on” and “based at least in part on.” The term “logic” includes, but is not limited to, computer software and/or firmware and/or hardwired configurations. The term “software” includes logic implemented as computer readable program code and/or machine readable instructions stored on a non-transitory computer readable medium (or media) and executable by a processor and/or processing unit(s).

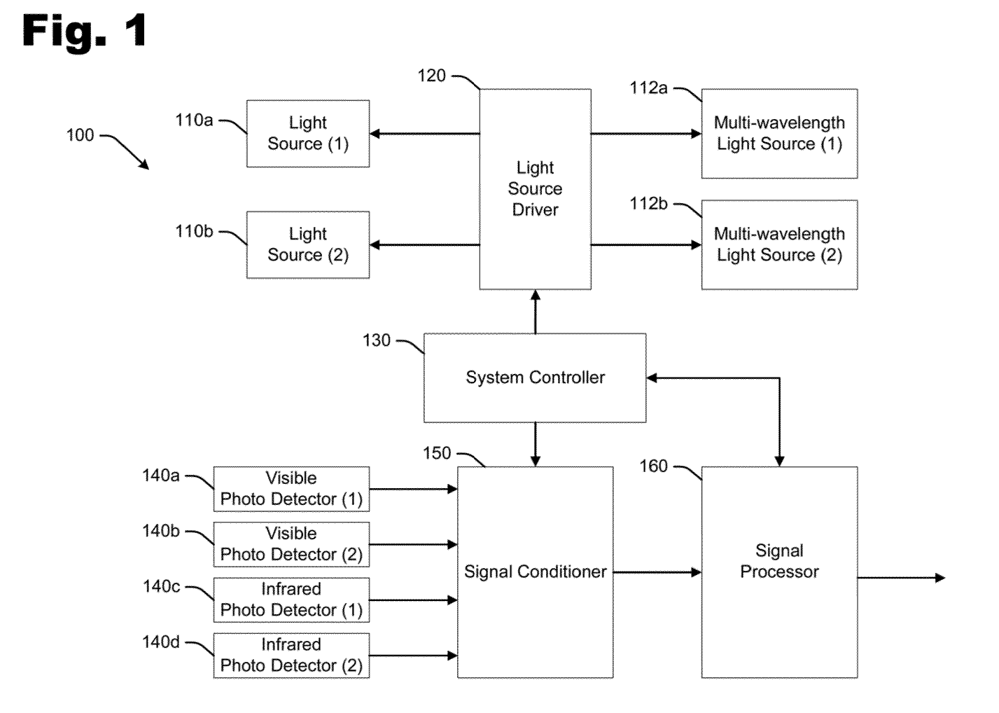

FIG. 1 is a system diagram of an example liquid contaminant sensor system 100. In an example, the system 100 can be implemented as an “in-line” (or flow-through) sensor to monitor for particles or other contaminants in the effluent of a water (or other fluid) treatment or purification system. In an example, the system 100 may be utilized to verify that medical grade water is being produced by the treatment system. Monitoring may occur substantially in real-time and thus may be implemented as part of (or following) the treatment or purification process.

In an example, the fluid to be monitored may be directed through a transparent or substantially clear flow path, thereby enabling optical techniques to detect the presence of particles or contaminants in the fluid. While various optical techniques may be implemented to detect particles, illustrative optical methods include Mei and Rayleigh scattering techniques. Both of these techniques use both forward and back scatter sensors. It is noted, however, that other techniques may also be implemented.

The example system 100 includes at least one light source (e.g., light sources 110a-b and 112a-b are shown in FIG. 1). By way of illustration, the light source may include, but is not limited to one or more (e.g., an array) Light Emitting Diode (LED), Laser Diode, HeNe Laser, or Incandescent Lamp. In an example, the light source 112a-b may be configured to emit multiple wavelengths. By way of illustration, wavelengths of about 375 nm to 500 nm may be emitted to detect small particles (e.g., in the range of about 5 nm to 35 nm). Wavelengths of about 500 nm to 950 nm may be emitted to detect mid-size particles (e.g., in the range of about 35 nm to 200 nm). Wavelengths such as about 950 nm 1620 nm may be emitted to detect large particles e.g., in the range of greater than about 200 nm). In an example, a light polarizer may be implemented to polarize the light emitted by the light source 110a-b and/or 112a-b.

The example system 100 may also include a light source driver 120. The light source driver 120 may be configured to generate a high power pulse to provide more optical energy for scattering. By way of illustration, the light source driver 120 may generate light energy of greater than about 1 Watt per pulse, produce a pulse duration of about 100 μsec, and perform on a duty cycle of about 0.1 (e.g., 100 μsec on, and 900 μsec off). In an example, the light source driver 120 may implement synchronous modulation for noise reduction.

The example system 100 may also include system controller 130. In an example, the system controller 130 may be configured to manage synchronous modulation/demodulation of the emitted light signal.

The example system 100 may also include at least one light detector. In an example, the light detector(s) may include visible photodetectors 140a-b and/or infrared photodetectors 142a-b. Suitable light detectors include, but are not limited to Si photo diodes, In—Ga—As photodiodes, focal plan arrays (e.g., Si), and light polarizers.

The example system 100 may include a signal conditioner 150. Suitable signal conditioners include, but are not limited to a synchronous detector, analog-to-digital (A-to-D) converter, current-to-frequency converter.

The example system 100 may include a signal processor 160, such as but not limited to a digital signal processor (DSP). An algorithm may also be implemented (e.g., by specially programming the signal processor and/or related processor) to convert signal information to particle size and/or count.

The example system 100 may also include optical coupling of the light source to the fluid flow cell. Optical coupling may be provided by angles, collimating the light signal, and/or use of mirrors, to name only a few examples. The example system 100 may also include optical collectors. Optical collectors may include, but are not limited to lenses, integrating spheres, and fiber-optic bundles. It should also be noted that the fluid flow cell may have any suitable geometry. For example, the fluid flow cell may be square or rectangular with radiused corners. These and other aspects of the example system 100 will be readily apparent to those having ordinary skill in the art after becoming familiar with the teachings herein.

During use, the example system 100 may be operated by emitting light from the light source(s) 110a-b and/or light source(s) 112a-b into a fluid flow cell. A light signal is detected by the light detector(s) 140a-b and/or light detector(s) 142a-b. In an example, both a reference signal (e.g., generated in fluid which is free of any particles) and a test signal (e.g., the fluid being tested for particles) are detected and compared. The light signal(s) may be processed to determine whether the fluid includes particle(s).

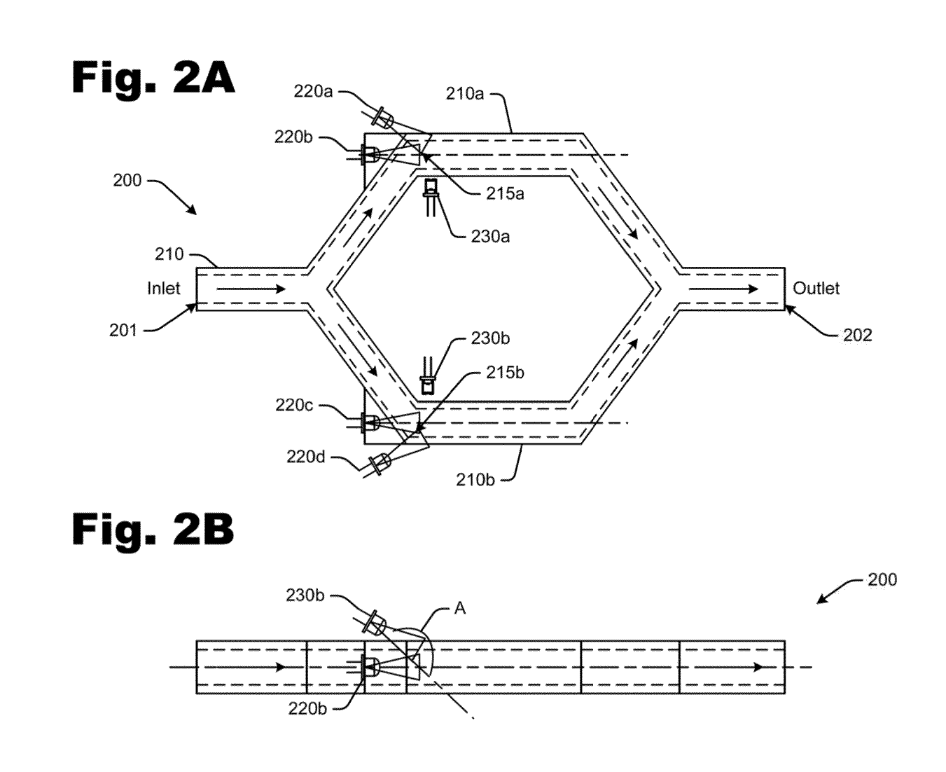

FIG. 2A is a top view of an example liquid contaminant sensor system 200; and FIG. 2B is a side view of an example liquid contaminant sensor system 200. In an example, the system 200 may be a fluid flow cell, e.g., with an inlet port 201 and an outlet port 202 which can be connected in-line at the effluent of a treatment or purification system. These ports 201, 202 may be made from low leaching material. The ports 201, 202 can be configured to support barb fittings, Luer lock fittings, bond socket, quick disconnect, or a number of other fittings. In another example, the system 200 may be formed as part of or otherwise integrated into the treatment or purification system.

The example system 200 includes a fluid flow path 210 which may be split into flow cells 210a-b, thereby providing both a reference flow path (e.g., through flow cell 210a) and a test flow path (e.g., through flow cell 210b). Of course, the fluid flow cell 210 may be split into any number of flow cells.

In the example shown, two paths 210a-b are used to create a differential measurement of particles. Each flow channel 210a-b is designed to maintain laminar flow, and thus maintain a uniform parabolic velocity profile. The cross section of the flow channel may be designed to minimize eddy currents in the corners of the flow channel. In an example, the flow channels 210a-b are square with radiused corners. The fluid flows through the flow channels 210a-b and then recombines and exits the sensing area 215a-b.

Each flow channel 210a-b may be made from an optically clear material so as to reduce scattering and absorption of the optical energy. The internal channel geometry may be designed to reduce optical scattering and keep the fluid in laminar flow. The external geometry of the sensing channel may be flat on the top and on the sides.

Sensing areas 215a-b are defined in each flow channel 210a-b by light emitted by at least one light source 220a-d and at least one light detector 230a-b (e.g., a photodiode, Avalanche photodiode, Cadmium Sulfide detector). In an example, the light source 220a-d is configured to emit one or more wavelength optimized to produce scattering energy when the optical energy strikes a particle of a predetermined size (e.g., greater than 0.005 μm). In an example, the optical detector 230a-b is positioned so as to capture the forward and back scattered optical energy. At least a portion of the flow channel 210a-b is manufactured of optically clear material so that both the fluid and the side wall material have dissimilar index of refraction. As such, optical energy reflects and scatters as the optical energy enters and exits the sensing cell.

Techniques to measure particles can be generally categorized as shadowing, backscatter, forward scatter, a combination of forward- and back-scatter, and polarization. System 200 implements a shadowing technique. This technique uses a focused light source and a flow aperture. The flow path is narrowed to multiply the shadow effect on the photodetector 215a-b. Thus when a particle passes by the photodetector 215a-b, the light is blocked and there is a decrease in optical energy incident upon the photodetector.

To sense a small particle traversing the path of the flow channel without physical contact, an optical method incorporating backscatter is used. It is noted that the light source 220a-d may be a Light Emitting Diode (LED), Laser Diode, Incandescent Lamp, etc. The wavelengths of the light source may be optimized for the best forward- and back-scatter response (e.g., based on particle size). The wavelengths may also be selected based upon the material used in the sensing channels. In an example, the light sources are placed at an angle A, which is optimized for the best forward and back scatter considering wavelength, and sensing channel material. In addition, the light source may be pulsed to obtain higher optical energy, thus producing higher forward and back scatter energy.

In an example, a laser diode may emit light at a wavelength between about 400 nm and 700 nm to illuminate the sensing area 215a-b of the flow channel 210a-b. Optical energy from the laser diode may be continuous or pulsed, e.g., dependent upon the desired optical energy. In an example, the laser diode is positioned so its optical path is not perpendicular to the sensing cell surface. Optical energy is transmitted through the wall of the flow channel so as to fully illuminate the flow channel flow path. When a particle enters the channel flow path and is illuminated by the light source, photons are forward- and back-scattered.

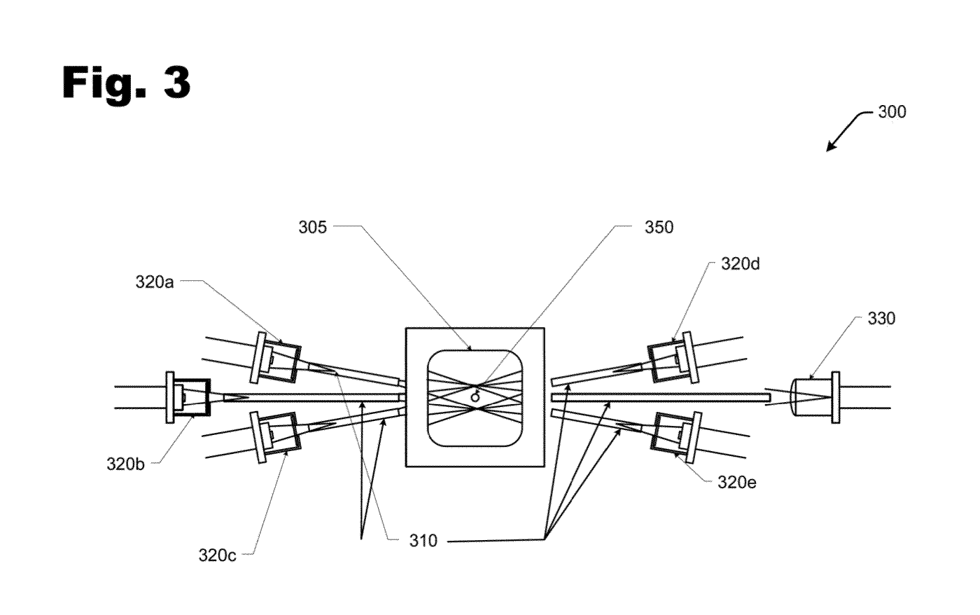

In an example, the water exiting the water purification system has passed through an ultrafilter with a pore size of approximately 5 nm. As such, the exiting water should have no particles greater than 5 nm. For Rayleigh scattering to be effective, the wavelength of the incident light is greater than about 10 times the particle size. Therefore, the incident light should have a wavelength greater than >50 nm for a 5 nm particle. To better differentiate the particle size, both forward and backscatter sensors may be used, as illustrated in FIG. 3. In addition, the optical energy can be transmitted from the light source to the flow cell via a light pipe or fiber optic as illustrated in FIG. 3.

FIG. 3 is a cut-away view of an example liquid contaminant sensor system 300 implementing light pipes and/or fiber optics to couple the optical signal or light emitted by the light source(s) to the flow (or sensing) channel(s). It is noted that this configuration may be implemented in each of the separate channels 305 (e.g., channels 210a-b shown in FIG. 2). Each flow channel has at least one photodetector 320a-e. In an example, photodetector 320a is a top-forward scatter photodetector, photodetector 320b is an LED/LD energy photodetector, photodetector 320c is a bottom-forward scatter photodetector, photodetector 320d is a top-back scatter photodetector, and photodetector 320e is a bottom-back scatter photodetector. Light source 330 is also shown.

The photodetectors 320a-e are positioned at suitable angles to optimize the forward- and/or back-scatter response. In addition, the photodetectors 320a-e are selected for peak responsivity at the light source wavelength(s). The forward- and back-scatter optical energy can be captured and transmitted to the photodetector via a light pipe or fiber optic 310 to detect particle 350 in the flow path 305.

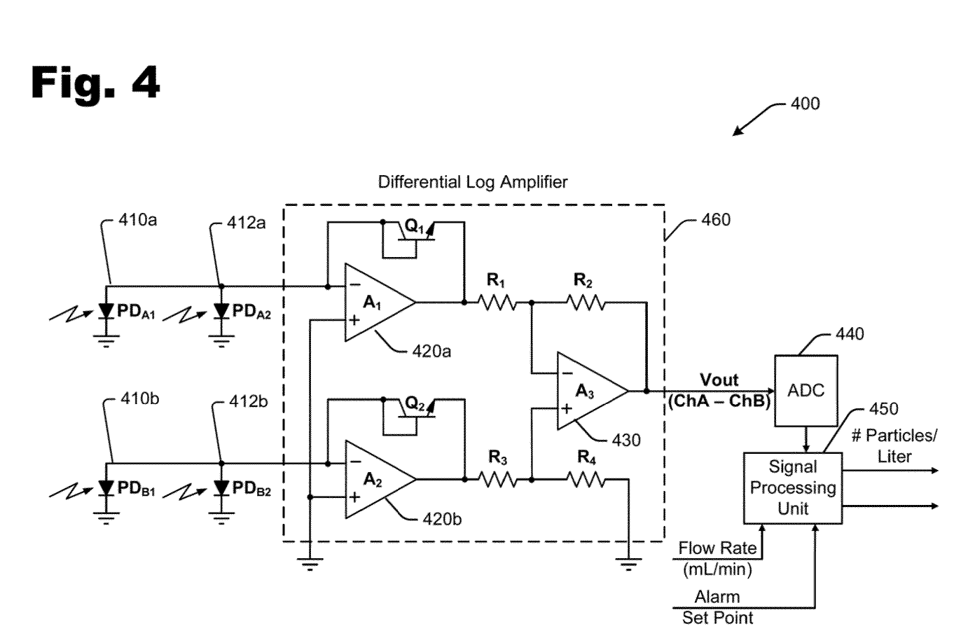

FIG. 4 is a schematic diagram of an example detection circuit 400 for a liquid contaminant sensor system. The example circuit 400 includes photodiodes 410a and 412a for a first flow path (e.g., flow channel 210a in FIG. 2), and photodiode 410b and 412b for a second flow path (e.g., flow channel 210b in FIG. 2). The circuit 400 may include a differential log amplifier 460. In an example, the differential log amplifier 460 sums the sensor's electrical current for each flow channel's forward- and back-scattered light, and feeds an electrical signal into transimpedance amplifiers 420a-b to convert current to voltage. An example transimpedance amplifier is a logarithmic amplifier. The output of the transimpedance amplifiers 420a-b is fed into a difference amplifier 430. Thus, the signal to noise ratio can be increased by removing the steady state background noise. The output voltage (Vₒᵤₜ signal) may be converted to a digital signal by analog-to-digital converter 440 and processed by the signal processing unit 450.

When a particle flows through the first flow channel (e.g., flow channel 210a in FIG. 2), then the output voltage (Vu signal) increases and remains higher until the particle passes the view area. Likewise, when a particle flows through the second flow channel (e.g., flow channel 210b in FIG. 2), then the output voltage (Vₒᵤₜ signal) decreases and remains lower until the particle passes the viewing area. If a particle flows through both the first and second channels at about the same time, then the output voltage increases and decreases as the particles pass the viewing area. As such, the output signal (Vₒᵤₜ signal) from the differential logarithmic amplifier 460 indicates when a particle traverses the field of view or sensing area of the flow path.

Signal processing unit 450 may generate various output(s), e.g., numbers of particle per liter, and/or generate an alarm if particle count exceeds a predetermined threshold. Other output may also be generated, e.g., an alarm. With the ability to detect the forward- and back-scatter optical energy and via use of multiple discrete wavelengths for the light source, individual particles can be counted and differentiated in size. In addition, sizing can be determined which enable assumptions to be made whether the particle is a bacteria, virus, or possible pyrogenic.

To improve the signal to noise for small particles (e.g., in the range of about 5 nm to 100 nm), the light source can be pulsed (e.g., instead of being continuously on). Pulsing the light source helps in several ways. First the forward- and back-scatter energy increases proportionally by the increase of the pulsed energy, thus resulting in a higher optical sensor current. Second, by pulsing the light source, synchronous modulation/demodulation techniques can be implemented (e.g., a lock-in amplifier). When a synchronous modulation/demodulation method is used, the background noise is shifted up in frequency by the frequency of the modulation frequency. By shifting the background noise up in frequency, it is easier to filter out noise.

Another technique to improve the signal-to-noise ratio (SNR) is to emit light at multiple different wavelengths (355 nm, 385 nm, 415 nm, 470 nm, 525 nm, 570 nm, 590 nm, 605 nm, 625 nm, 645 nm, 808 nm, 880 nm, 940 nm). In addition to improving SNR, a light source with discrete multiple wavelengths enables differentiating size of the particles in the flow path (e.g., based on Mie and Rayleigh scattering principles). That is, depending upon the size of the particle, the forward- and back-scatter signal is unique and wavelength dependent, thus enabling the circuit to discriminate by particle size.

While an example liquid contaminant sensor system has been described above with reference to FIGS. 2-3, other techniques to capture the forward- and back-scattered photons are also contemplated. In another example, highly reflective small integrating spheres are placed on either side of the flow channel(s). In an example, the surface of the integrating sphere(s) may be coated with a metal (e.g., gold) or other material to reduce the reflection losses. A one way mirror may be provided on the flow channel wall to permit the photons to freely travel into the integrating sphere. Photons “bounce around” on the wall of the integrating sphere until exiting the viewing hole. Several sensor types may be used to detect the exiting photon, such as but not limited to, an avalanche photo diode, a silicon photo diode, and/or any other type of photodetector (e.g., having high gain).

FIG. 5 is a system diagram of another example liquid contaminant sensor system 500 having integrating spheres 510a-b and 512a-b. Two flow channels may be provided in the sensing cell to cancel out flow channel background noise produced by diffused laser diode optical energy, ambient light, and electrical noise.

In the example shown in FIG. 5, each flow channel 505a-b has two integrating spheres (although other configurations are possible). Integrating spheres 510a and 512a are provided on each side of flow channel 505a; and integrated spheres 510b and 512b are provided on each side of flow channel 505b. Each integrating sphere 510a-b and 512a-b may have a corresponding photodetector 520a-b and 522a-b. The photodetectors (e.g., 520a and 522a; and 520b and 522b) current can be summed for each flow channel 505a, 505b.

In an example, a differential method may be implemented to accommodate background noise. To increase sensitivity to small particles, a logarithmic amplifier 530a-b may be provided to sum the photodetector's current and to convert the output to a voltage before outputting a signal 540 from the differential amplifier 545. For example, a differential amplifier may subtract one flow cell logarithmic amplifier output from the other. Another method of performing the subtraction is to use a differential logarithmic amplifier (e.g., Texas Instruments LOG114). Thus, when small particles pass through the viewing area of the sensing cell, output signal 540 from the logarithmic amplifier 545 increases or decreases in voltage.

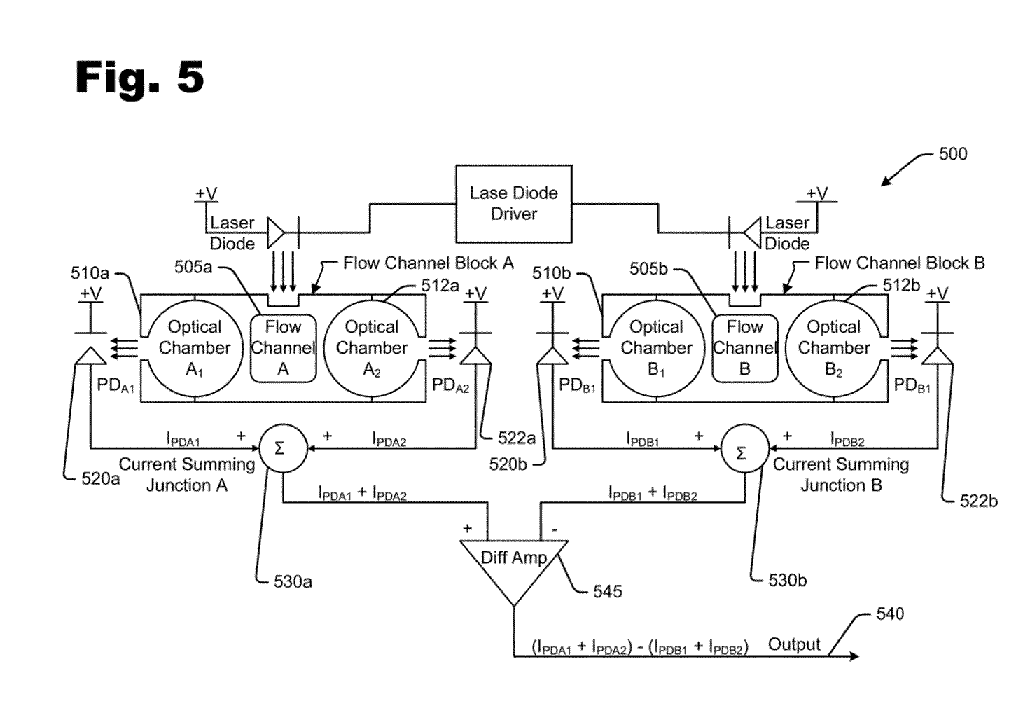

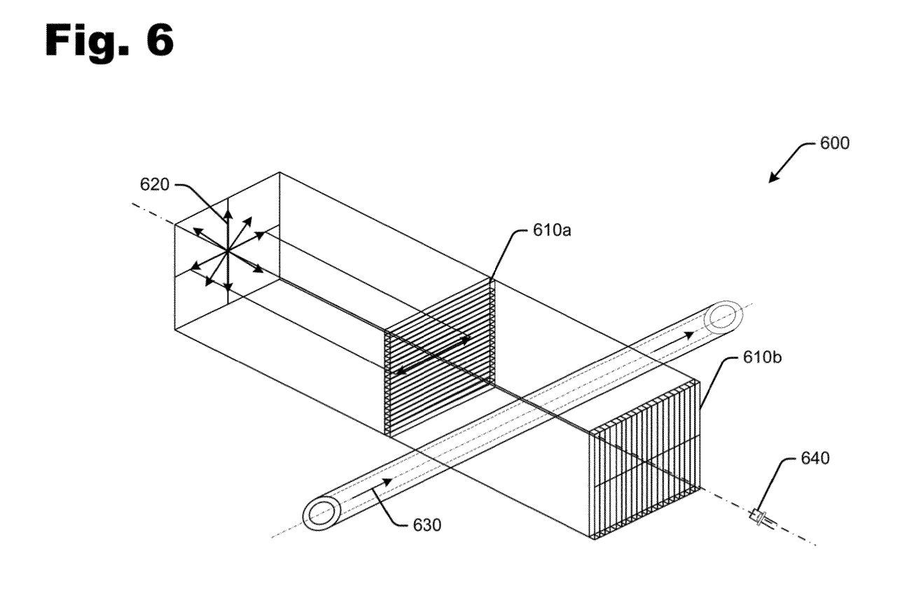

FIG. 6 is perspective view of another example liquid contaminant sensor system 600. Example system 600 implements two light polarizers 610a-b (although any number of polarizers may be implemented). A light source 620 is directed to the first polarizer 610a, and polarized light passes through the polarizer 610a. Then the polarized light passes through a flow cell 630. As light passes through the flow cell 630, the light enters the second polarizer 610b. Polarizer 610b is rotated to block (or null) the incoming polarized light from polarizer 610a. The residual light exiting polarizer 610b is captured by a photodetector 640.

When water with no particles is passing through the flow cell 630, the photodetector 640 detects little light because the polarizers 610a-b are blocking the light due to phase shift of the polarizers 610a-b. When particles pass into the measurement area 635 of the flow cell 630, the particles scatter the light and change the phase of the light, thus allowing the out-of-phase light to pass through polarizer 610b. The out-of-phase light exiting polarizer 610b is captured by the photodetector 640, and indicates that a particle has passed through the flow cell 630.

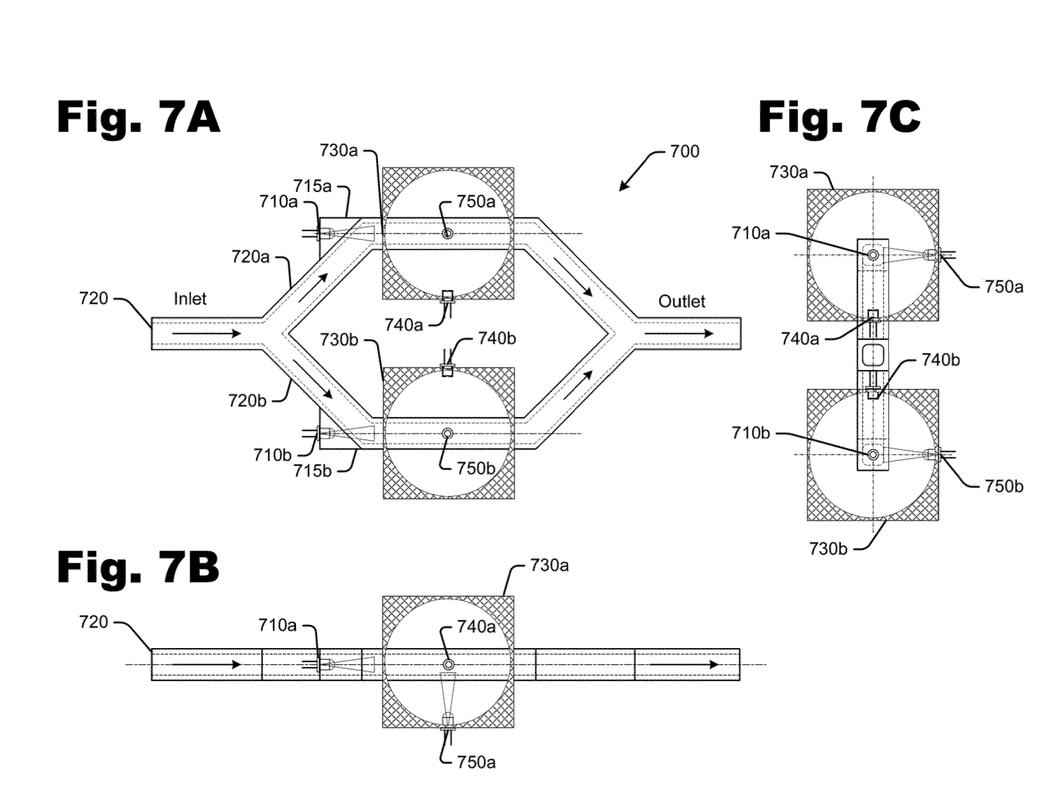

FIG. 7A is a top view of the example liquid contaminant sensor system 700 implementing the forward and back scattering technique. FIG. 7B is a side view of an example liquid contaminant sensor system 700; and FIG. 7C is an end view of an example liquid contaminant sensor system 700.

Example system 700 includes two collimated light sources 710a-b to illuminate the length of the flow cell (e.g., instead illuminating from the top of the flow cell), as can be seen in FIGS. 7A and 7B. In an example, the light sources 710a-b are positioned to emit light in the direction of fluid flow, thus increasing the time of scattering and the amount of optical energy emitted as the particle traverses the length of the flow cells 720a-b. Thus, the particle velocity and size determines the amount of total optical energy emitted. In an example, optical couplings 715a-b couple the collimated light source 710a-b to the flow cell 720a-b so as to direct the light down the length of the flow path.

In addition to detecting particles, system 700 may be implemented as a discrete spectral photometer, e.g, by adding a narrow beam multi-wavelength light source 750a-b to the bottom of the integrating sphere. That is, the multi-wavelength light source 750a-b illuminates the flow cell 720a-b, and at a predetermined wavelength, optical energy is adsorbed by the chemical content of the fluid in the flow cell 720a-b, thus creating a discrete spectral photometer. The output of the photodetector 740a-b may be sampled by an analog-to-digital converter and the resulting digital output signal processed by a processor to determine the concentration of monitored chemicals. By quantifying the chemical concentrations, the system 700 may verify that the proper concentrations are exiting a treatment or purification system.

To capture forward- and back-scattered light, an integrating sphere 730a-b is incorporated around the flow cell 720a-b. The flow cell 720a-b enters along a center axis of integrating spheres 730a-b, and exits along the same center axis. The light source 710a-b couples to the flow cell 720a-b outside of the integrating sphere 730a-b. Thus, when a particle enters the flow path, photons hit the particle and scatter. The photons tend to scatter outside of the flow cell 720a-b and hit the inside of integrating spheres 730a-b to be captured (e.g., after several bounces in the integrating sphere 730a-b) by a photodetector 740a-b.

It is noted that this technique can be employed to greatly increase the signal to noise ratio. In addition to capturing scattered photons from particles in the fluid, the integrating spheres 730a-b may also capture non-adsorbed photon(s) from a multi-wavelength light source 750a-b, thus creating a discrete spectral photometer.

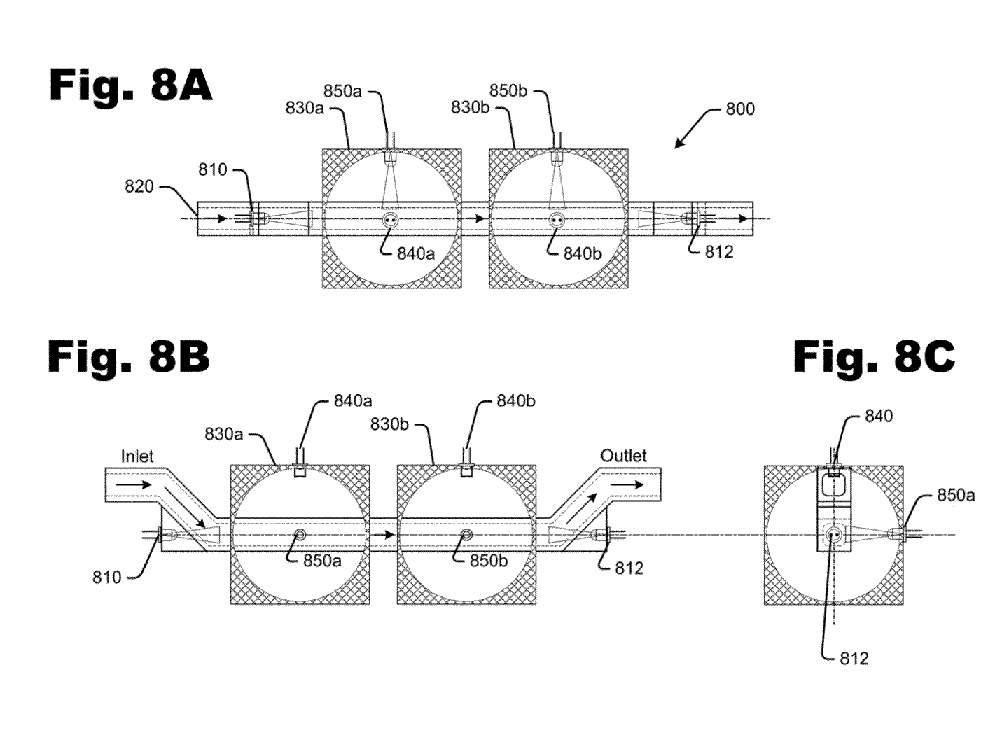

FIG. 8A is a top view of an example liquid contaminant sensor system 800. FIG. 8B is a side view of an example liquid contaminant sensor system 800. FIG. 8C is an end view of an example liquid contaminant sensor system 800. A light polarizer may also be provided for system 800.

Example system 800 includes collimated light source 810 to illuminate the length of the flow cell. In an example, the light sources 810 is positioned to emit light in the direction of fluid flow, thus increasing the time of scattering and the amount of optical energy emitted as the particle traverses the length of the flow cell 820. Thus, the particle velocity and size determines the amount of total optical energy emitted. In some ways this simplifies the design by having a single flow path. To be able to provide enough optical energy, a second light source 812 may be directed in the counter flow direction.

In addition to detecting particles, system 800 may be implemented as a discrete spectral photometer. e.g., by adding a narrow beam multi-wavelength light source 850a-b to the bottom of each integrating sphere 830a-b. That is, the multi-wavelength light source 850a-b illuminates the flow cell 820, and at a predetermined wavelength, optical energy is adsorbed by the chemical content of the fluid in the flow cell 820, thus creating a discrete spectral photometer. The output of the photodetector 840a-b may be sampled by an analog-to-digital converter and the resulting digital output signal processed by a processor to determine the concentration of monitored chemicals. By quantifying the chemical concentrations, the system 800 may verify that the proper concentrations are exiting a treatment or purification system.

To capture forward- and back-scattered light, an integrating sphere 830a-b is incorporated around the flow cell 820. The flow cell 820 enters along a center axis of integrating spheres 830a-b, and exits along the same center axis. The light source 810 couples to the flow cell 820 outside of the integrating sphere 830a-b. Thus, when a particle enters the flow path, photons hit the particle and scatter. The photons tend to scatter outside of the flow cell 820 and hit the inside of integrating spheres 830a-b to be captured (e.g., after several bounces in the integrating sphere 830a-b) by a photodetector 840a-b.

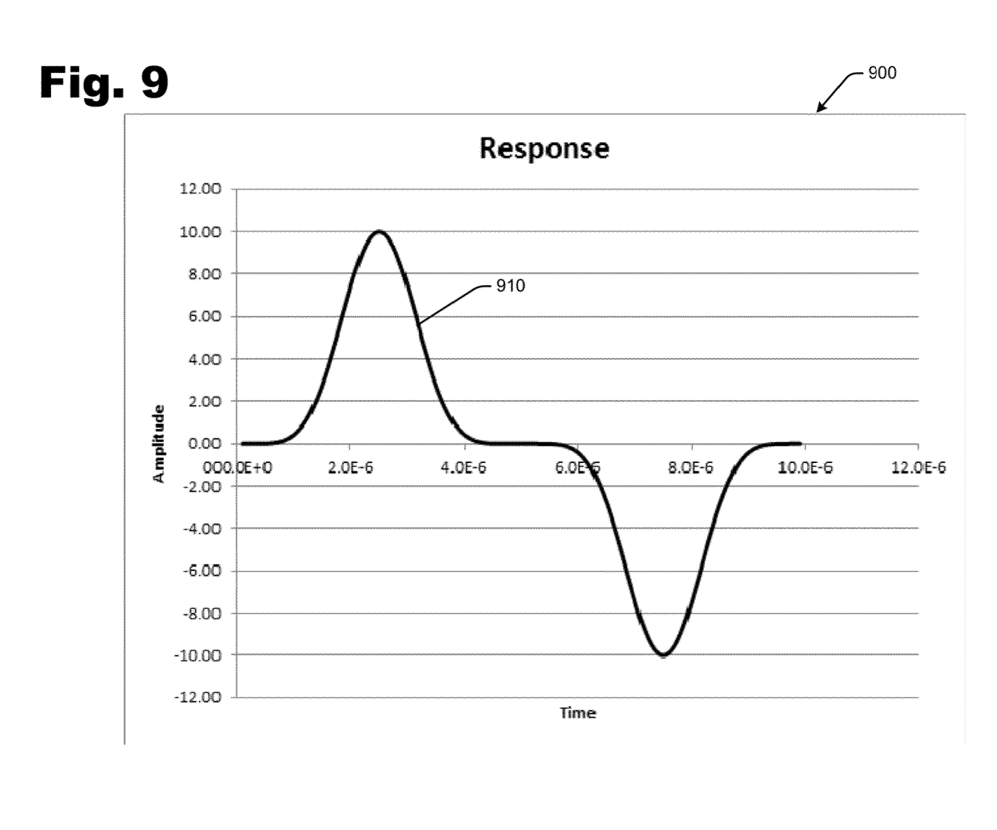

FIG. 9 is plot 900 showing response of a particle flowing through a flow cell of an example liquid contaminant sensor system (e.g., system 800 described with reference to FIGS. 8A-C). The response curve 910 is a plot of amplitude over time (t). The response is amplitude measured by the first photodetector minus the amplitude measured by the second photodetector. Positive and negative pulses are a result of differences between the photodetectors. That is, as the particle transvers the flow cell, a first integrating sphere detects the particle, thus producing a positive signal. When the same particle flows in the integrating cell, the difference between the first photodetector (for the first flow channel) and the second photodetector (for the second flow channel) creates a negative output.

Before continuing, it should be noted that the examples described above are provided for purposes of illustration, and are not intended to be limiting. Other devices and/or device configurations may be utilized to carry out the operations described herein.

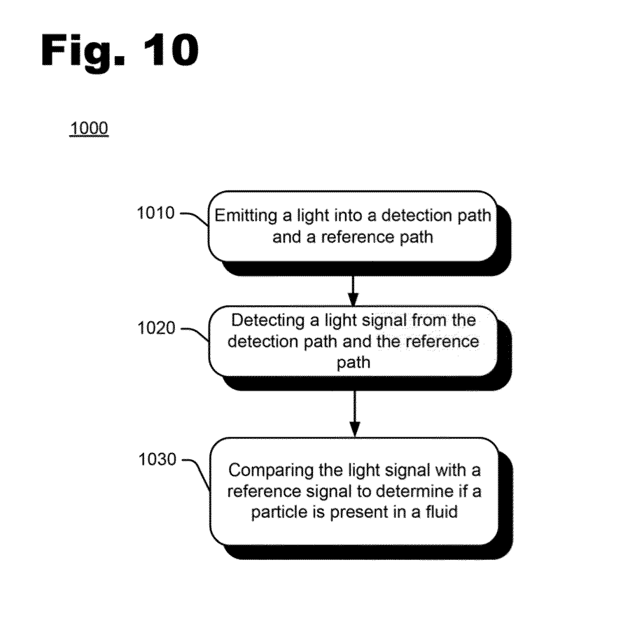

FIG. 10 is flow chart showing example operations 1000 of a liquid contaminant sensor method. In an example, the components and connections depicted in the figures may be used.

Example operation 1010 includes emitting a light into a detection path and a reference path. Example operation 1020 includes detecting a light signal from the detection path and the reference path. Example operation 1030 includes comparing the light signal with a reference signal to determine if a particle is present in a fluid.

The operations shown and described herein are provided to illustrate example implementations. It is noted that the operations are not limited to the ordering shown. Still other operations may also be implemented.

By way of non-limiting illustration, example operations may include splitting a fluid path into a detection path and a reference path. Example operations may include polarizing the light emitted into the detection path and the reference path. Example operations may include coupling the light to the detection path and the reference path.

The operations may be implemented at least in part using an end-user interface. In an example, the output generated by the method described above is output to a user. In an example, the end-user interface also includes a user-input interface, enabling the user to make selections. It is also noted that various of the operations described herein may be automated or partially automated.

It is noted that the examples shown and described are provided for purposes of illustration and are not intended to be limiting. Still other examples are also contemplated.

1. A liquid contaminant sensor system, comprising:
at least one light source;
at least one light detector to receive a light signal from the at least one light source; and
a signal processor to compare the light signal received at the at least one light detector and determine presence and/or magnitude of biological matter, particles, molecules, or elements present in a liquid.

2. The liquid contaminant sensor system of claim 1, further comprising:
a flow cell in a fluid path split into separate paths;
sensing channels for the flow cell;
a light source for each sensing channel; and
a photodetector for each sensing channel.

3. The liquid contaminant sensor system of claim 2, wherein the reference signal is from one of the sensing channels.

4. The liquid contaminant sensor system of claim 1, further comprising a safety check circuit to process at least a first check for chemical content of the liquid, and a second check for particle or biological contamination.

5. The liquid contaminant sensor system of claim 1, further comprising a safety check circuit implementing non-contact particle measurement.

6. The liquid contaminant sensor system of claim 1, further comprising a light pipe for the at least one light source.

7. The liquid contaminant sensor system of claim 1, further comprising at least one integrating sphere.

8. The liquid contaminant sensor system of claim 1, further comprising at least one light polarizer.

9. The liquid contaminant sensor system of claim 1, further comprising a light source driver to emit a high power pulse of light from the at least one light source.

10. The liquid contaminant sensor system of claim 1, further comprising an optical coupling of the at least one light source to a flow cell.

11. The liquid contaminant sensor system of claim 1, further comprising at least one optical collector.

12. The liquid contaminant sensor system of claim 1, further comprising at least one light signal conditioner.

13. The liquid contaminant sensor system of claim 1, further comprising synchronous modulation/demodulation processor.

14. The liquid contaminant sensor system of claim 1, further comprising a processor configured to output size and/or count of particle or biological matter in the liquid.

15. The liquid contaminant sensor system of claim 1, further comprising a processor configured to output the magnitude of chemical contents in the liquid.

16. A liquid contaminant sensor system, comprising:
a flow cell in a fluid path split into separate paths;
a sensing channel for each path;
a light source for each sensing channel;
a photodetector for each sensing channel; and
a signal processor to compare the light signal received at the at least one light detector with a reference signal and determine at least one of presence and magnitude of biological matter, particles, molecules, or elements present in a liquid, wherein the reference signal is from one of the sensing channels.

17. A liquid contaminant sensor method, comprising:
emitting a light into a detection path and a reference path;
detecting a light signal from the detection path and the reference path; and
comparing the light signal with a reference signal to determine if biological matter, particles, elements, or molecules are present in a fluid.

18. The method of claim 17, further comprising splitting a fluid path into a detection path and a reference path.

19. The method of claim 17, further comprising polarizing the light emitted into the detection path and the reference path.

20. The method of claim 17, further comprising coupling the light to the detection path and the reference path.
